(19) United States
(12) Patent Application Publication
(10) Pub. No.: US 2010/0088606 A1
(43) Pub. Date: Apr. 8, 2010

(54) IMAGE PROCESSING SYSTEM, SERVER APPARATUS, CLIENT APPARATUS, CONTROL METHOD, AND STORAGE MEDIUM

(75) Inventor: Asuka Kanno, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/574,026

(22) Filed: Oct. 6, 2009

(30) Foreign Application Priority Data
Oct. 7, 2008 (JP) 2008-260707

(51) Int. Cl. G06F 15/16; G06F 3/048

(52) U.S. Cl. 715/733

(57) ABSTRACT

An image processing system includes a server apparatus and a client apparatus connected to each other via a network. The client apparatus inputs text and pieces of font attribute information and transmits the text and information to the server apparatus. The server apparatus stores pieces of rendering shape information of characters and transmits pieces of rendering shape information corresponding to pieces of font attribute information received from the client apparatus to the client apparatus. The client apparatus generates an image corresponding to the text on the basis of the pieces of rendering shape information received from the server apparatus and displays the image in a display device. Particularly, the server apparatus transmits pieces of rendering shape information corresponding to individual characters in the received text to the client apparatus. The client apparatus generates images of the characters. Accordingly, a character string received from the server apparatus can be easily modified.

### BACKGROUND OF THE INVENTION

1. Field of the Invention

The present invention relates to an image processing system including a server apparatus and a client apparatus that are connected to each other via a network.

2. Description of the Related Art

In a typical server-client system, fonts are arranged on a server apparatus side. Accordingly, a user can express characters by using various types of font not existing in a client apparatus. For example, there is a technique in which a server apparatus generates image data by using a font requested by a client apparatus and transmits the image data to the client apparatus.

In that technique, however, much processing time is necessary for communication with the server apparatus and generation of image data of the font until the client apparatus obtains image data after making a request. As one of techniques for reducing such processing time, U.S. patent application No. 2005/0080839 discloses a technique in which image data of a font is generated by a server apparatus and is stored in the server apparatus. With this technique, when image data of a font selected by a user has already been stored in the server apparatus, a client apparatus only needs to read the image data, so that the processing time can be reduced.

After the client apparatus has received a character string from the server apparatus by using the foregoing technique, the user may want to modify the character string.

However, in the above-described related art, the server apparatus reads a character string requested by the client apparatus as a piece of image data. Therefore, this method is disadvantageous in that it is impossible to dynamically modify the character string in the client apparatus. That is, in order to dynamically modify the character string, transmission/reception of the image data between the client apparatus and the server apparatus is necessary during the modification.

Furthermore, when the user performs such modification, the user repeats generation and display of the image data in order to check the character string under modification in many cases. Therefore, repeated communication between the client apparatus and the server apparatus is necessary, causing a longer processing time, which results in poor operability for the user.

### SUMMARY OF THE INVENTION

In view of the above-described problems, the present invention provides an image processing system capable of modifying a character string received from a server with improved operability in a case where fonts are arranged on a server apparatus side.

According to an embodiment of the present invention, an image processing system includes a server apparatus and a client apparatus connected to each other via a network. The server apparatus includes a storage unit configured to store pieces of rendering shape information of characters, a receiving unit configured to receive text and pieces of font attribute information from the client apparatus, and a first transmitting unit configured to transmit, to the client apparatus, pieces of rendering shape information corresponding to the received pieces of font attribute information among the pieces of rendering shape information of the characters stored in the storage unit. The client apparatus includes an input unit configured to input text and pieces of font attribute information, a second transmitting unit configured to transmit, to the server apparatus, the text and the pieces of font attribute information that have been input, a generating unit configured to generate an image corresponding to the text on the basis of pieces of rendering shape information received from the server apparatus, and a display control unit configured to allow a display device to display the image generated by the generating unit. The first transmitting unit transmits, to the client apparatus, pieces of rendering shape information corresponding to individual characters included in the received text. The generating unit generates images corresponding to the individual characters included in the text.

Further features of the present invention will become apparent from the following description of exemplary embodiments with reference to the attached drawings.

### BRIEF DESCRIPTION OF THE DRAWINGS

FIG. 1 illustrates a configuration of an image processing system according to a first embodiment of the present invention.

FIG. 2 illustrates a physical configuration of a client apparatus according to the first embodiment.

FIG. 3 illustrates a physical configuration of a server apparatus according to the first embodiment.

FIG. 4 illustrates a software configuration of the client apparatus and the server apparatus according to the first embodiment.

FIG. 5 illustrates a GUI screen of an application in the client apparatus of the image processing system according to the first embodiment.

FIG. 6 illustrates a data structure of text information according to the first embodiment.

FIG. 7 illustrates a data structure of glyph information according to the first embodiment.

FIG. 8 illustrates a data structure of output image information according to the first embodiment.

FIG. 9 is a flowchart illustrating an output image generating process performed in the image processing system according to the first embodiment.

FIG. 10 illustrates the GUI screen after text has been input according to the first embodiment.

FIG. 11 illustrates the GUI screen after an output image has been generated according to the first embodiment.

FIG. 12 illustrates an example of a case of decreasing the width of an output image according to the first embodiment.

FIG. 13 is a flowchart illustrating a procedure of decreasing the width of an output image according to the first embodiment.

FIG. 14 illustrates an example of an output image after the width has been decreased according to the first embodiment.

FIG. 15 is a flowchart illustrating a procedure of increasing the width of an output image according to the first embodiment.

FIG. 16 illustrates an output image after the width has been increased according to the first embodiment.

FIG. 17 illustrates a software configuration of the client apparatus and the server apparatus according to a second embodiment of the present invention.

FIG. 18 illustrates a data structure of character information according to the second embodiment.

FIG. 19 is a flowchart illustrating a procedure of performing an output image generating process according to the second embodiment.

### DESCRIPTION OF THE EMBODIMENTS

Hereinafter, an image processing system according to an embodiment of the present invention is described with reference to the attached drawings. First, necessary information for character rendering is described. In typical character rendering, the following information is necessary.

First of all, the necessary information includes “font”. This is information indicating the shape of characters specified as a face name, such as a Gothic typeface and a Mincho typeface, and includes rendering shapes (glyphs) corresponding to individual characters. “Glyphs” indicate rendering shapes of individual characters and serve as a component of a font. Furthermore, the necessary information includes “metrics”. This is layout information that defines the size of space occupied by characters and that is used for displaying characters, and includes a glyph width and kerning between characters. Those pieces of information are necessary for character rendering.

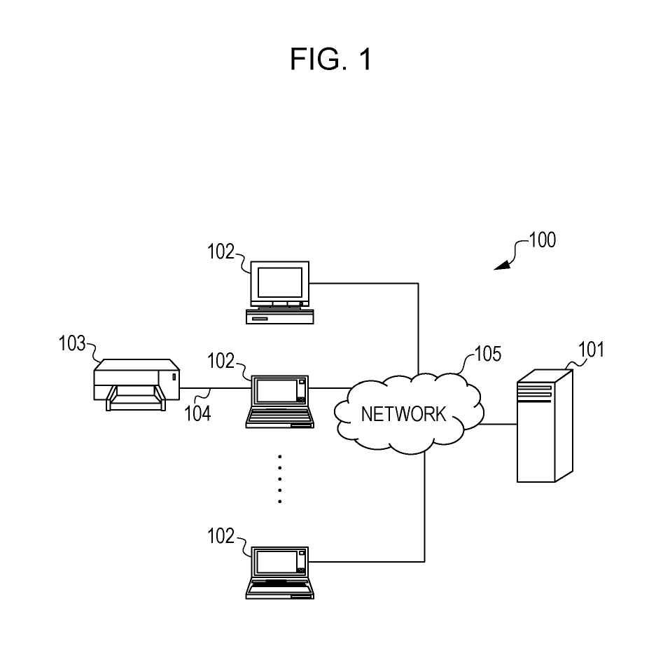

FIG. 1 illustrates a configuration of an image processing system 100 according to a first embodiment of the present invention. The image processing system 100 includes a server apparatus 101 and one or a plurality of client apparatuses 102 connected to the server apparatus 101 via a network 105, such as the Internet or an intranet. The server apparatus 101 provides data to the client apparatus 102 in response to a request for the data from the client apparatus 102. The request includes a request for generating an output image. The server apparatus 101 is a computer including an OS (Operating System) for servers and includes a storage medium that stores a plurality of fonts.

In this embodiment, the server apparatus 101 is a Web server that provides a Web application for generating data to be printed. Furthermore, the client apparatus 102 downloads the Web application from the server apparatus 101 and executes it by using browser software.

The client apparatus 102 is connected to a printer 103 through a data-transferring interface cable 104. The interface cable 104 is used to transfer image data to the printer 103 under control by the client apparatus 102. The printer 103 prints and outputs image data in accordance with control by the client apparatus 102.

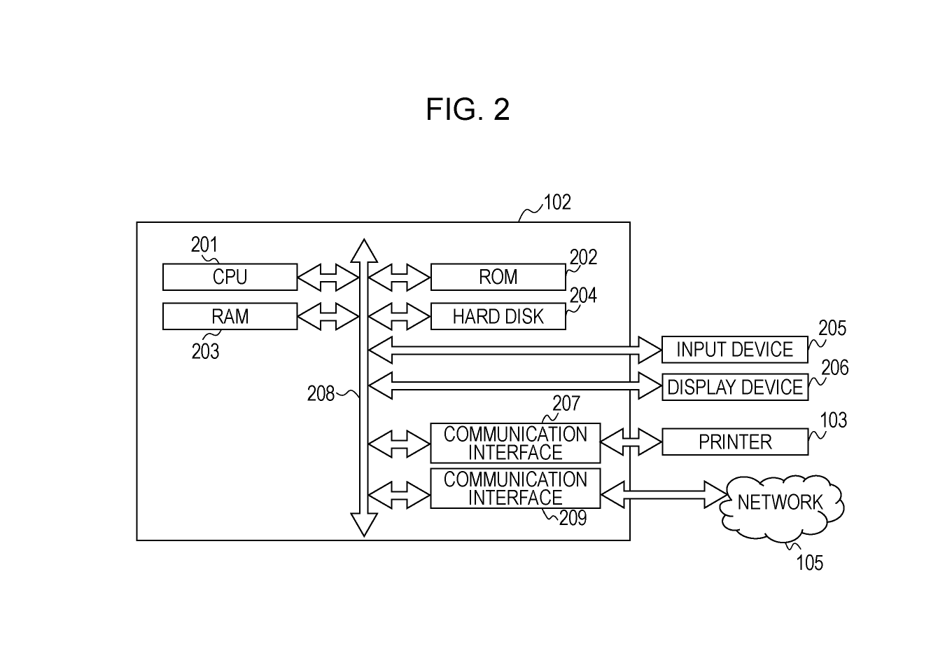

FIG. 2 illustrates a physical configuration of the client apparatus 102 according to the first embodiment. As illustrated in FIG. 2, the client apparatus 102 includes a CPU (Central Processing Unit) 201 capable of interpreting and executing program instructions, a ROM (Read Only Memory) 202 that stores execution codes and data of an OS and software, and a RAM (Random Access Memory) 203 serving as a temporary storage area. The CPU 201 executes a program stored in the ROM 202 by using the RAM 203 as a work area, thereby controlling the entire client apparatus 102.

A hard disk 204 is a nonvolatile storage device and is capable of storing various data. An input device 205 is used as a user interface. An instruction caused by a user operation is input to the CPU 201 through a system bus 208, and the CPU 201 performs control in accordance with the instruction. That is, an instruction from a user can be input through an operation of the input device 205. Examples of the input device 205 include a mouse and a keyboard. A display device 206 can display various data, such as character data and image data, in accordance with control by the CPU 201.

The client apparatus 102 further includes a communication interface 207 that transmits/receives information to/from the printer 103, and a communication interface 209 that communicates with the network 105. As illustrated in FIG. 2, data is transmitted/received among the respective components through the system bus 208.

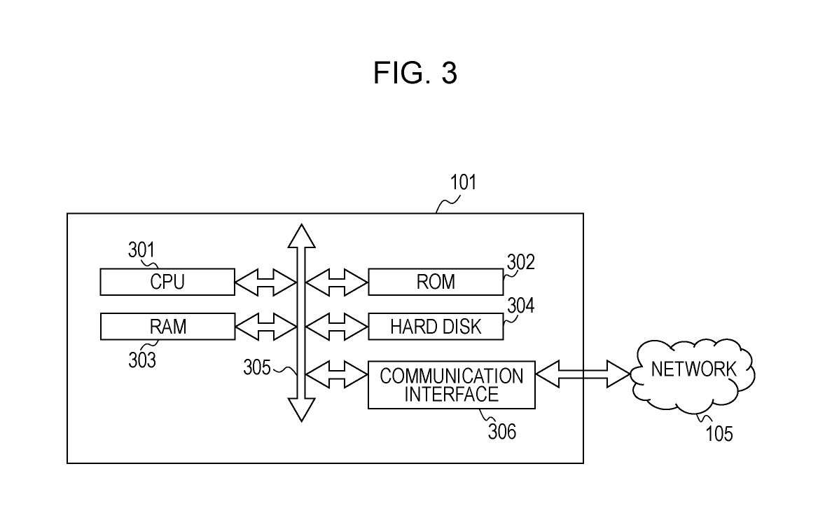

FIG. 3 illustrates a physical configuration of the server apparatus 101 according to the first embodiment. As illustrated in FIG. 3, the server apparatus 101 includes a CPU 301 capable of interpreting and executing program instructions, a ROM 302 that stores execution codes and data of an OS and software, and a RAM 303 serving as a temporary storage area. The CPU 301 executes a program stored in the ROM 302 by using the RAM 303 as a work area, thereby controlling the entire server apparatus 101.

A hard disk 304 is a nonvolatile storage device and is capable of storing various data. Furthermore, the server apparatus 101 includes a communication interface 306 that communicates with the network 105. As illustrated in FIG. 3, data is transmitted/received among the respective components through a system bus 305.

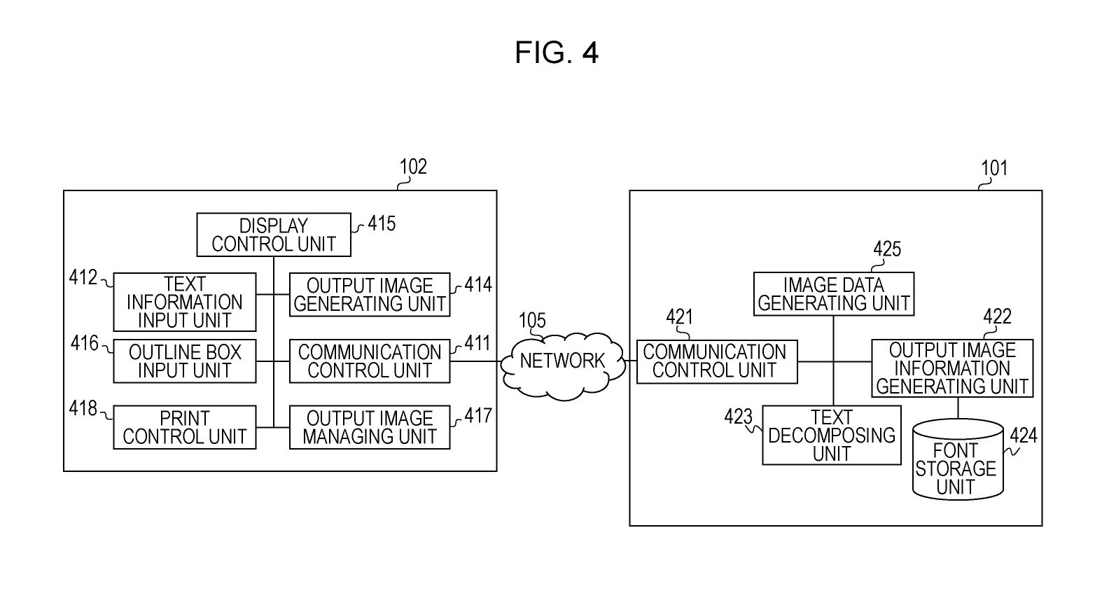

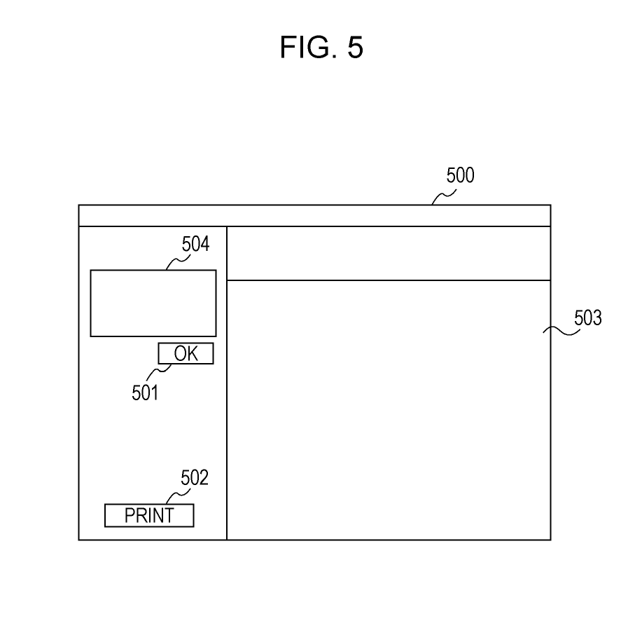

FIG. 4 illustrates a configuration of software according to the first embodiment. The functions constituting the software illustrated in FIG. 4 are described by also referring to FIG. 5.

FIG. 4 illustrates the client apparatus 102 and the server apparatus 101. In this configuration, the client apparatus 102 transmits/receives data to/from the server apparatus 101 via a communication control unit 411. On the other hand, the server apparatus 101 receives a request from the client apparatus 102 via a communication control unit 421 and transmits data corresponding to the request to the client apparatus 102.

A display control unit 415 allows the display device 206 to display a GUI (Graphical User Interface) screen. FIG. 5 illustrates a GUI screen 500 of an application in the client apparatus 102 of the image processing system according to the first embodiment. In the client apparatus 102, the application is executed with use of browser software, displays the GUI screen 500 for generating data to be printed, and accepts operations.

A text information input unit 412 is an input interface that accepts an input of text information, which includes text input through a mouse or keyboard and font attribute information, such as a font family, a font style, a font size, and a font color. Examples of the font family include a Gothic typeface and a Mincho typeface specified as a face name. Examples of the font style include bold and italic.

Regarding the font attribute information, a list of font types stored in a font storage unit 424 of the server apparatus 101 is displayed on the GUI screen 500, so that a user is allowed to select a font from the list. The user selects a font type displayed on the GUI screen 500 by operating the input device 205, such as a mouse, and also inputs text. Then, by specifying an OK button 501, the user can input an instruction to determine text information. The text information input through such a user operation is transmitted to the server apparatus 101 via the communication control unit 411.

An output image generating unit 414 generates an output image in which characters are arranged. At this time, the characters are arranged with reference to the metrics of the individual characters. In a case where an output image has already been displayed on the GUI screen 500, the coordinates of the output image on the GUI screen 500 and rectangle information including an outline size of the output image have been registered, which are also referred to. Details of the process performed in the output image generating unit 414 are described below.

The display control unit 415 allows the display device 206 to display an image. Particularly, in this embodiment, an output image generated by the output image generating unit 414 is displayed in a preview area 503 of the GUI screen 500 on the basis of the rectangle information.

An outline box input unit 416 is an input interface, interprets a user operation performed on the input device 205, and determines an instruction provided from a user about an editing process for an outline box of a character string. For example, in a case of an interface using a mouse for input, when a dragging operation with the mouse is performed at the position where an output image is displayed in the preview area 503, an instruction according to the operation is input. Then, a process corresponding to the operation is determined in the outline box input unit 416, and an editing process for an image, such as selection, modification, rotation, scaling-up/down, line space adjustment, or movement of the image, is accepted as an instruction from the user.

An output image managing unit 417 manages all output images displayed on the GUI screen 500 and pieces of rectangle information corresponding to the output images. Also, at generation or modification of an output image, the output image managing unit 417 updates the rectangle information in accordance with information supplied from the outline box input unit 416. Furthermore, when a button 502 for making a print request is selected by a user, the output image managing unit 417 transmits information of all output images displayed in the preview area 503 and the rectangle information to the server apparatus 101 via the communication control unit 411. Then, image data is received from the server apparatus 101 via the communication control unit 411, and a print control unit 418 outputs the received image data to the printer 103.

Next, the server apparatus 101 is described. In the server apparatus 101, the communication control unit 421 transmits/receives data to/from the client apparatus 102. A text decomposing unit 423 decomposes text included in text information received from the client apparatus 102 via the communication control unit 421 into character codes.

An output image information generating unit 422 generates output image information by using a font stored in the font storage unit 424. The output image information includes the received text information and pieces of rendering shape information (glyph information) corresponding to the individual characters obtained through decomposition performed by the text decomposing unit 423. The glyph information is obtained from the fonts stored in the font storage unit 424. The output image information generated in this manner is transmitted to the client apparatus 102 via the communication control unit 421.

An image data generating unit 425 generates image data on the basis of the output image information and rectangle information received from the client apparatus 102 via the communication control unit 421. The image data generated in this manner is transmitted to the client apparatus 102 via the communication control unit 421.

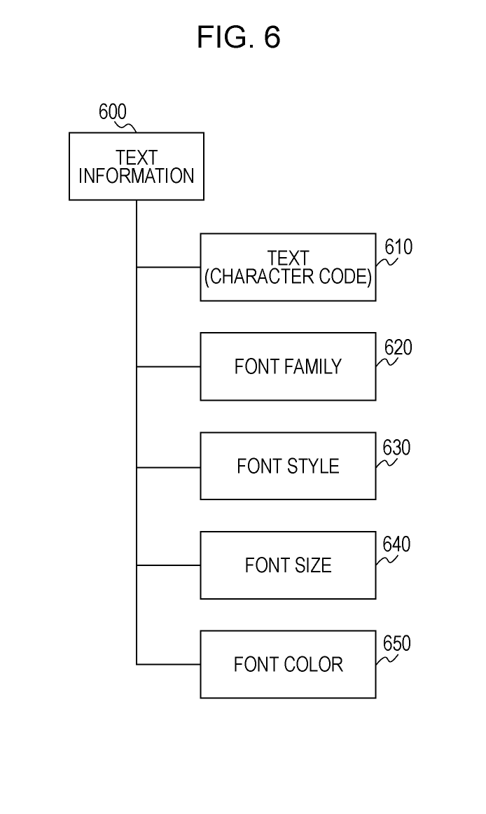

FIG. 6 illustrates a data structure of text information 600 according to the first embodiment. The text information 600 includes text 610 including at least one character code input by the text information input unit 412, and a font family 620, a font style 630, a font size 640, and a font color 650 of the text. As described above, the text information is transmitted from the client apparatus 102 to the server apparatus 101.

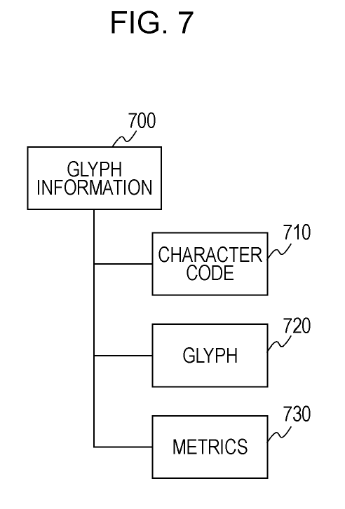

FIG. 7 illustrates a data structure of glyph information 700 according to the first embodiment. In this embodiment, the glyph information 700 exists for each of characters in a one-to-one relationship. The glyph information 700 includes at least a character code 710, a glyph 720 corresponding to the character code 710, and metrics 730.

The glyph 720 represents the shape of the character, in the form of vector data, for example. The metrics 730 represents the layout of the character, and includes at least ascent, descent, set width, right-side bearing, left-side bearing, and kerning. The glyph 720 may be a bitmap font or a vector font. Alternatively, the glyph 720 may be a monospaced font or a proportional font.

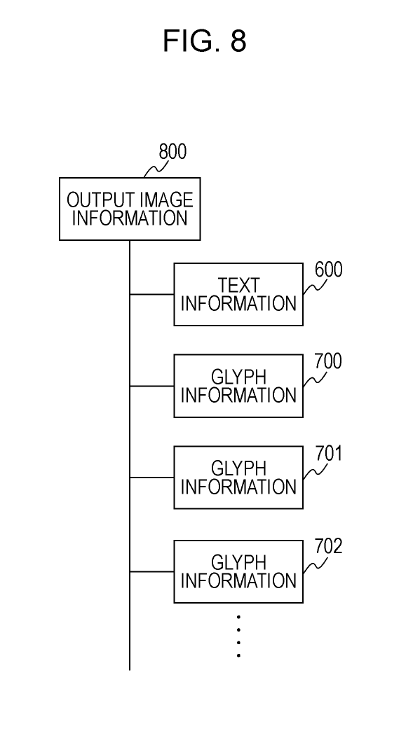

FIG. 8 illustrates a data structure of output image information 800 according to the first embodiment. The output image information 800 includes the text information 600 and pieces of glyph information 700, 701, 702, . . . corresponding to individual characters included in the text 610. Each of the pieces of glyph information 701, 702, . . . has the same structure as that of the glyph information 700 described above with reference to FIG. 7. In this embodiment, the number of pieces of glyph information included in the output image information 800 (the number being represented by “n”) is the same as the number of characters in the text 610 included in the text information 600. As described above, the output image information is generated by the output image information generating unit 422 of the server apparatus 101.

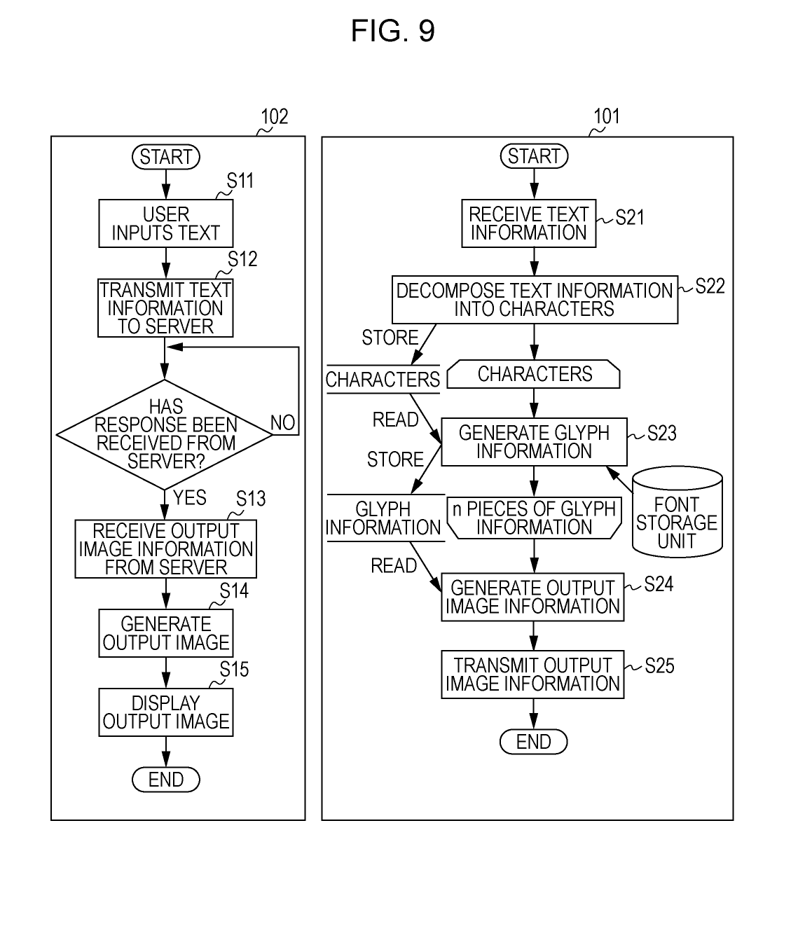

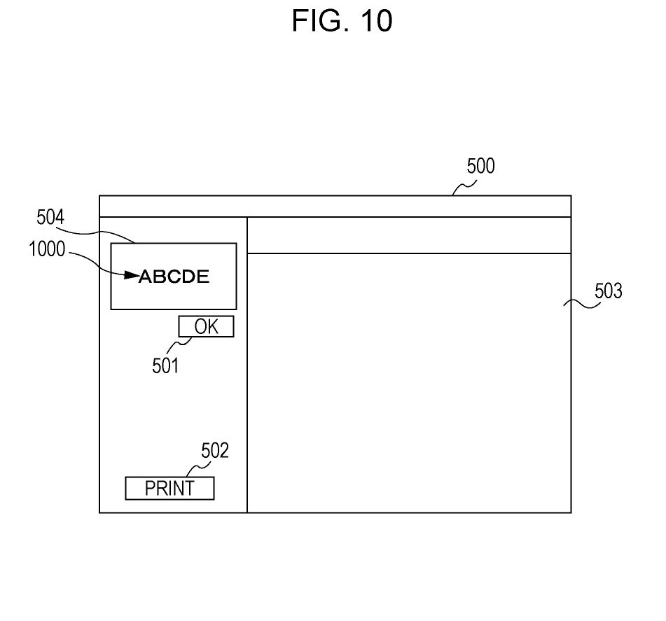

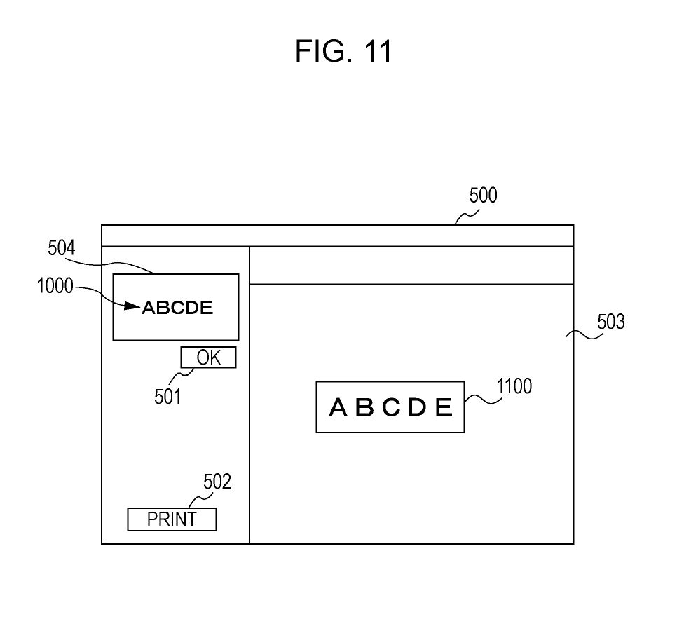

FIG. 9 is a flowchart illustrating an output image generating process performed in the image processing system according to the first embodiment. FIG. 10 illustrates the GUI screen 500 after text has been input according to the first embodiment. FIG. 11 illustrates the GUI screen 500 after an output image has been generated according to the first embodiment. With reference to FIGS. 9, 10, and 11, a procedure of generating an output image according to this embodiment is described.

First, in step S11, the GUI screen 500 illustrated in FIG. 5 has already been displayed in the display device 206. In this state, a user operates the input device 205, such as a keyboard. When an instruction caused by this operation is input to the text information input unit 412, one or a plurality of characters 1000 are displayed in accordance with the operation, as illustrated in FIG. 10. When the user selects the OK button 501 by operating a mouse or the like, the process proceeds to step S12. In step S11, a list of fonts stored in the font storage unit 424 of the server apparatus 101 is displayed on the GUI screen 500. When the user selects a font, the font family 620 and the font style 630 are determined.

In step S12, the input text information 600 is transmitted to the server apparatus 101 via the communication control unit 411. This can be called a second transmission. That is, the input text and the font attribute information thereof are stored as the text information 600 in the server apparatus 101. After transmitting the text information 600 in step S12, the client apparatus 102 enters a waiting state to wait for a response from the server apparatus 101.

Next, a process performed by the server apparatus 101 is described. In step S21, the text information 600 transmitted from the client apparatus 102 is received via the communication control unit 421. This can be called a first reception. In step S22, the text 610 included in the text information 600 is decomposed into character codes, each code corresponding to each character, by the text decomposing unit 423.

In step S23, glyph information corresponding to the character code of each of the characters obtained through the decomposition in step S22 is generated. Specifically, glyph information is generated with reference to the font storage unit 424 on the basis of the font family 620, the font style 630, the font size 640, and the font color 650 of the text information 600 and the character code of one character. Step S23 is repeatedly performed for the number of characters included in the text 610, whereby n pieces of glyph information 700, 701, 702, . . . are generated.

In step S24, the output image information generating unit 422 generates the output image information 800 including the n pieces of glyph information generated in step S23 and the text information 600. In step S25, the output image information 800 generated in step S24 is transmitted to the client apparatus 102 via the communication control unit 421. This can be called a first transmission.

The client apparatus 102, which has been in a waiting state since transmission of the text information in step S12, proceeds to step S13 when the output image information 800 is transmitted from the server apparatus 101 in step S25.

In step S13, the output image information 800 that is generated by and transmitted from the server apparatus 101 is received via the communication control unit 411. This can be called a second reception. In step S14, the output image generating unit 414 generates an output image 1100 by arranging, on the coordinates calculated based on individual metrics, character images obtained from individual glyphs included in the n pieces of glyph information in the output image information 800 received from the server apparatus 101. At this time, the output image generating unit 414 may generate a new image in which characters are arranged, or may simply generate and arrange character images.

In step S15, the output image 1100 generated in step S14 is displayed at the center of the preview area 503, as illustrated in FIG. 11. At this time, the coordinates on the GUI screen 500 of the output image 1100 and rectangle information indicating the outline size of the output image 1100 are registered in the output image managing unit 417.

The displayed output image 1100 is modified in accordance with an instruction from the user input through the outline box input unit 416.

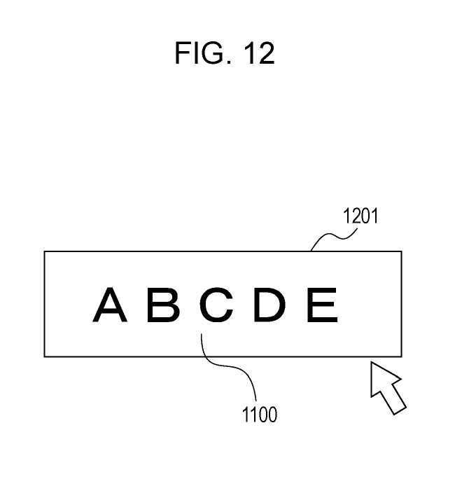

FIG. 12 illustrates an example of a case where the width of the output image 1100 is decreased. A decreasing process is performed in accordance with an input to the outline box input unit 416. Specifically, the user moves the right side of an outline box 1201 to the left by dragging with a mouse, whereby the width is decreased. While the width is being decreased by dragging with the mouse, the decrease is determined by the outline box input unit 416. Also, the coordinates of the outline box 1201 are determined.

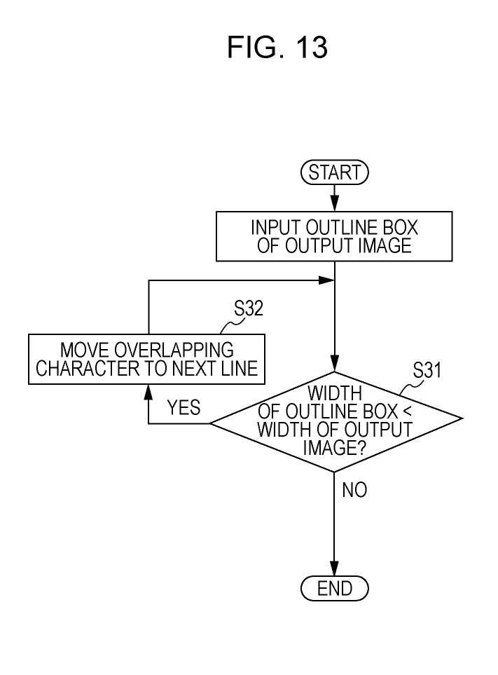

FIG. 13 is a flowchart illustrating a procedure of decreasing the width of the output image 1100 according to the first embodiment. While the decrease is being determined by the outline box input unit 416, steps S31 and S32 are repeated.

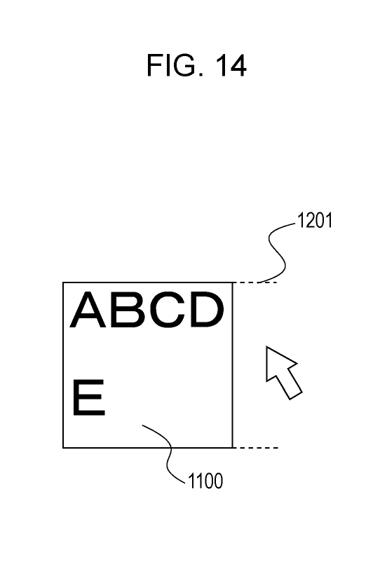

In step S31, the width of the output image 1100 is compared with the width of the outline box 1201, whereby it is determined whether the outline box 1201 and the output image 1100 overlap with each other. At this time, the width of the output image 1100 can be obtained by referring to the rectangle information of the output image 1100 managed by the output image managing unit 417. When the width of the outline box 1201 is smaller than the width of the output image 1100, the rightmost character of the output image 1100 (in this case “E”) is moved to the next line in step S32. Specifically, the output image generating unit 414 generates a modified output image 1100 that is arranged on the coordinates calculated so that the glyph of the character “E” is within the width of the outline box 1201, on the basis of the metrics 730. Then, the output image 1100 is displayed in the display device 206 by the display control unit 415. Also, at this time, the rectangle information of the output image 1100 managed by the output image managing unit 417 is updated. FIG. 14 illustrates an example of the output image 1100 after the width has been decreased.

Next, a case of increasing the width of the output image 1100 is described. The user performs a dragging operation to the right by using the mouse, whereby the outline box input unit 416 moves the right side of the outline box 1201 to the right so as to increase the width. While the width is being increased with use of the mouse, the increase is determined by the outline box input unit 416. Also, the position of the outline box 1201 is determined based on the present coordinates of the mouse.

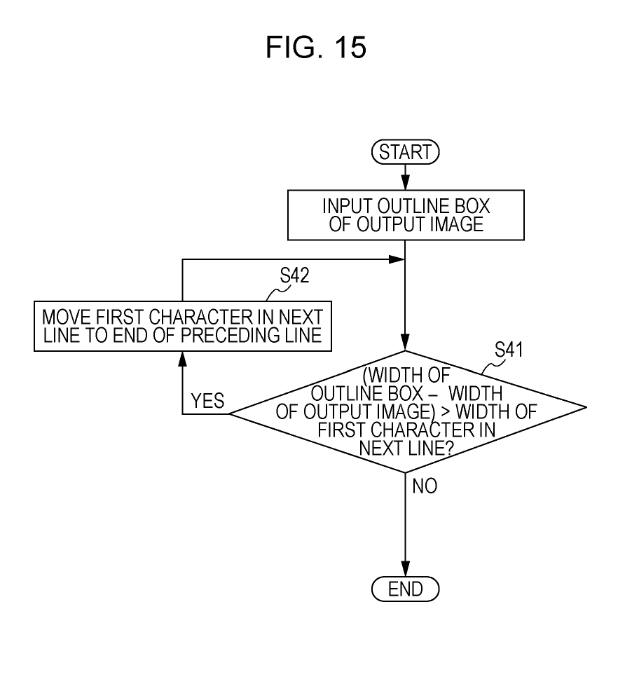

FIG. 15 is a flowchart illustrating a procedure of increasing the width of the output image 1100 according to the first embodiment. In this flowchart, steps S41 and S42 are repeated while the increase of the width of the outline box 1201 is being determined by the outline box input unit 416.

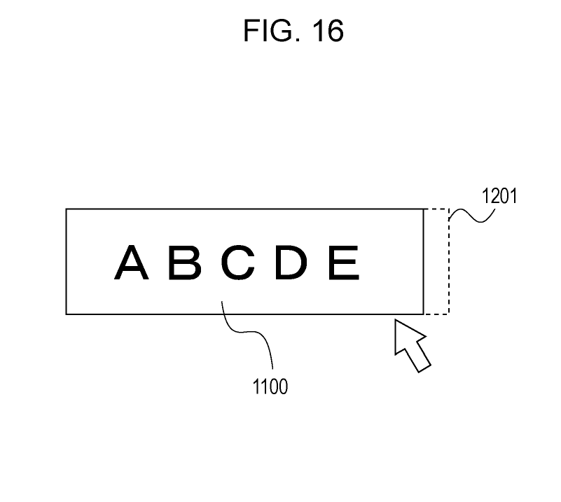

In step S41, a difference between the width of the output image 1100 and the width of the outline box 1201 is compared with the width of the first character in the next line (in this case “E”). At this time, the width of the output image 1100 can be obtained by referring to the rectangle information of the output image 1100 managed by the output image managing unit 417. The width of each character can be obtained by referring to the metrics 730 of the glyph information 700 corresponding to the character. When the width of the first character in the next line (in this case “E”) is smaller than the difference between the width of the output image 1100 and the width of the outline box 1201, “E” is moved to the end of the preceding line in step S42. Specifically, the output image generating unit 414 generates a modified output image 1100 in which the glyph of the character “E” is arranged within the width of the outline box 1201, on the basis of the metrics 730. Then, the output image 1100 is displayed in the display device 206 by the display control unit 415. FIG. 16 illustrates the output image 1100 after the width has been increased. At this time, the rectangle information of the output image 1100 managed by the output image managing unit 417 is updated.

After the modification has been performed in the client apparatus 102 in the above-described manner, when the user issues a print request, the output image information and rectangle information of the modified output image 1100 are transmitted to the server apparatus 101 via the communication control unit 411. Then, the image data is transmitted from the server apparatus 101 via the communication control unit 411, and the print control unit 418 outputs the received image data to the printer 103.

Here, a description has been given about modification of the output image 1100 including a line, but the output image 1100 may include a plurality of lines. Also, a description has been given about character arrangement through modification on the right side. However, the modification may be performed on the left side.

Also, a description has been given about the case where the output image information generating unit 422 of the server apparatus 101 generates pieces of glyph information corresponding to all the character codes included in the text 610. Alternatively, once-generated glyph information may be cached, and the cached glyph information may be taken out when character codes overlap. Furthermore, a description has been given about the case of displaying text in horizontal writing. However, the text may be displayed in vertical writing.

Furthermore, a description has been given about the case of generating image data to be printed by the server apparatus 101. Alternatively, the image data may be generated on the client side.

As described above, according to the configuration of this embodiment, text included in the text information 600 is decomposed, so that pieces of glyph information are generated. The client apparatus 102 generates an output image in which character images are arranged on the basis of the generated pieces of glyph information. Accordingly, a dynamic modification of the output image (character arrangement) can be performed with only the movement of the glyph 720 without communication with the server apparatus 101. Thus, a processing time can be shortened, and the user can modify a character string received from the server apparatus 101 with high operability. Furthermore, a load on the server apparatus 101 can be decreased.

Hereinafter, an image processing system according to a second embodiment of the present invention is described with reference to the drawings. In the above-described first embodiment, the client apparatus 102 transmits text information to the server apparatus 101, and the server apparatus 101 decomposes the text information into character codes, each corresponding to a character. On the other hand, in this embodiment, the client apparatus 102 decomposes text information into character codes, each corresponding to a character, and then transmits the character codes to the server apparatus 101. The configuration of the image processing system, the physical configuration of the client apparatus 102, and the physical configuration of the server apparatus 101 according to this embodiment are the same as those in the first embodiment illustrated in FIGS. 1, 2, and 3, and thus the corresponding description is omitted.

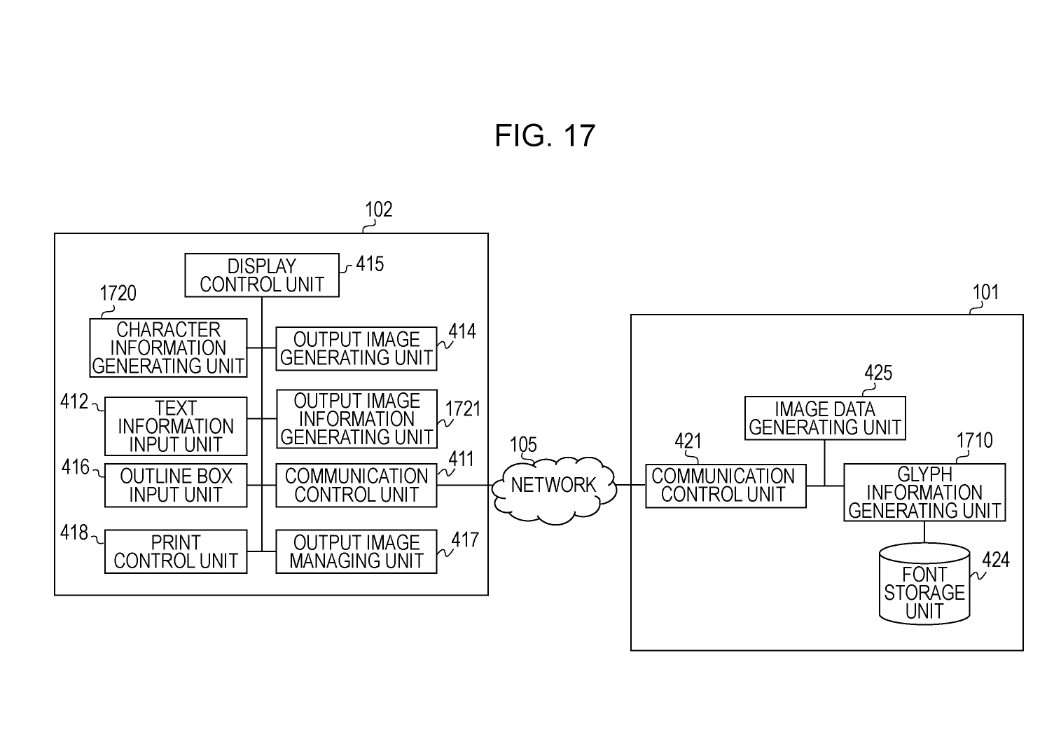

FIG. 17 illustrates a software configuration according to the second embodiment. Referring to FIG. 17, the configuration includes the client apparatus 102 and the server apparatus 101.

First, the client apparatus 102 is described. The communication control unit 411, the text information input unit 412, the output image generating unit 414, the display control unit 415, the outline box input unit 416, the output image managing unit 417, and the print control unit 418 are the same as those in the first embodiment, and thus the description thereof is omitted.

A character information generating unit 1720 decomposes text included in text information input to the text information input unit 412 into character codes, and then generates pieces of character information each including a character code and font attribute information such as a font family, a font style, a font size, and a font color. Regarding the font attribute information, a list of font types stored in the font storage unit 424 of the server apparatus 101 is displayed on the GUI screen 500, so that a user is allowed to select a font type from the list. The user selects a font type from the list displayed on the GUI screen 500 by operating the input device 205, such as a mouse, and further inputs text.

An output image information generating unit 1721 generates output image information including n pieces of glyph information 700, 701, 702, . . . received from the server apparatus 101 via the communication control unit 411. Details of this process are described below.

The communication control unit 421, the font storage unit 424, and the image data generating unit 425 in the server apparatus 101 are the same as those in the first embodiment, and thus the description thereof is omitted. A glyph information generating unit 1710 generates glyph information by using character information received from the client apparatus 102 via the communication control unit 421 and a font stored in the font storage unit 424.

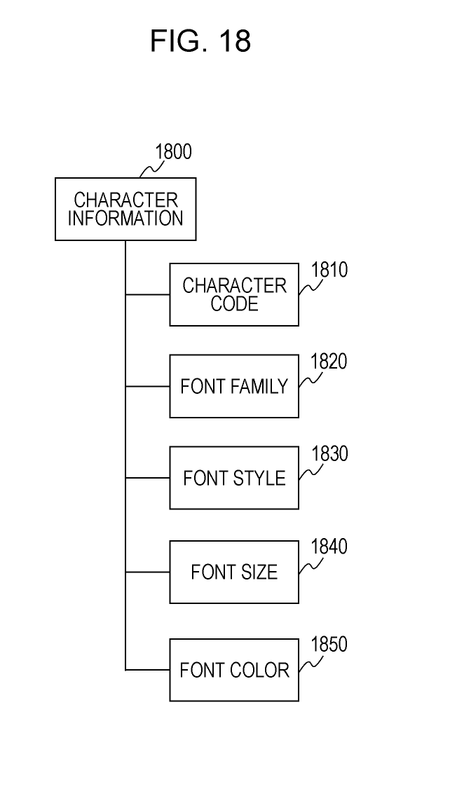

FIG. 18 illustrates a structure of character information 1800 according to the second embodiment. In this embodiment, a description is given about a case where the character information 1800 exists for each of characters in a one-to-one relationship. As illustrated in FIG. 18, the character information 1800 includes at least a character code 1810, a font family 1820, a font style 1830, a font size 1840, and a font color 1850.

The structure of text information, the structure of glyph information, and the structure of output image information according to this embodiment of the present invention are the same as those of the first embodiment illustrated in FIGS. 6, 7, and 8, and thus the description thereof is omitted. Also, examples of the GUI screen 500 according to this embodiment are the same as those in the first embodiment.

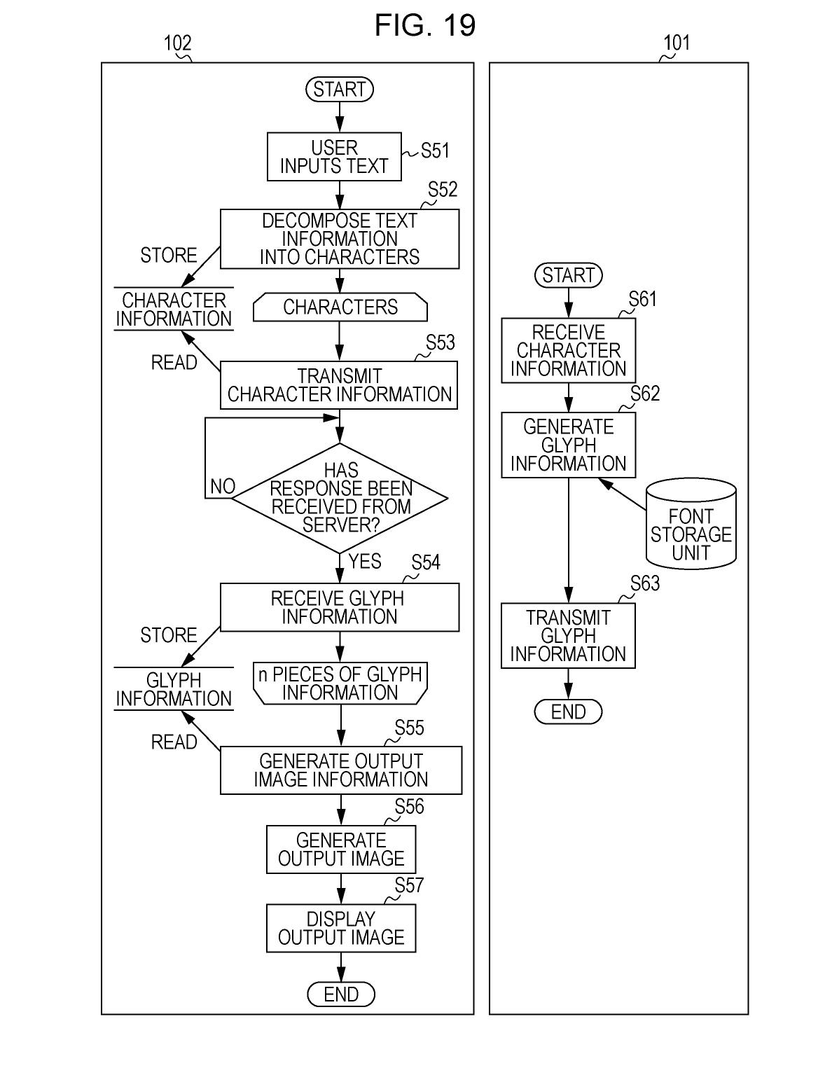

FIG. 19 is a flowchart illustrating a procedure of performing an output image generating process according to the second embodiment. An example of the GUI screen 500 after text has been input according to this embodiment is the same as that of the first embodiment illustrated in FIG. 10.

First, in step S51, the GUI screen 500 illustrated in FIG. 5 has already been displayed in the display device 206. In this state, a user operates the input device 205, such as a keyboard. When an instruction caused by this operation is input to the text information input unit 412, arbitrary text including at least one character is displayed, as illustrated in FIG. 10. In step S52, the user selects the OK button 501 on the GUI screen 500, whereby the input text is stored as the text information 600. Additionally, in step S51, a list of font types stored in the font storage unit 424 of the server apparatus 101 is displayed on the GUI screen 500. When the user selects a font type from the list, font attribute information including a font family, a font style, and the like is determined.

Furthermore, the character information generating unit 1720 generates pieces of character information of individual characters on the basis of character codes of the individual characters obtained through decomposition of the text, a font family, a font style, a font size, and a font color. Those elements in each piece of character information serve as the character code 1810, the font family 1820, the font style 1830, the font size 1840, and the font color 1850, respectively. In this embodiment, pieces of character information 1800, 1801, 1802, . . . , the number thereof being the same as the number n of characters included in the text, are generated. Each of the pieces of character information 1801, 1802, . . . has the same structure as that of the character information 1800.

In step S53, the client apparatus 102 transmits the character information 1800 generated in step S52 to the server apparatus 101 via the communication control unit 411 and enters a state of waiting for a response from the server apparatus 101. This transmission can be called a second transmission.

In step S61, the server apparatus 101 receives the character information 1800 transmitted from the client apparatus 102 via the communication control unit 421. This can be called a first reception. Then, in step S62, the glyph information generating unit 1710 generates glyph information 700. The glyph information 700 is generated by using the character information 1800 with reference to the font storage unit 424. In step S63, the generated glyph information 700 is transmitted to the client apparatus 102 via the communication control unit 421. This can be called a first transmission. When the glyph information 700 is transmitted from the server apparatus 101 to the client apparatus 102 in step S63, the client apparatus 102 proceeds to step S54. In step S54, the glyph information 700 of the character information 1800 transmitted in step S53 is received from the server apparatus 101. This can be called a second reception.

The above-described steps S53, S61, S62, S63, and S54 are repeated for the individual n characters included in the text 610. That is, pieces of character information for all the characters included in the text input by the user are generated and are transmitted to the server apparatus 101. After all pieces of glyph information have been received, the process proceeds to step S55.

In step S55, the output image information generating unit 1721 of the client apparatus 102 generates output image information 800 including the input text information 600 and the pieces of glyph information 700, 701, 702, . . . , the number of which is the same as the number n of the characters included in the text. In step S56, the output image generating unit 414 generates the output image 1100 illustrated in FIG. 11. At this time, the output image generating unit 414 generates the output image 1100 by arranging, on the coordinates calculated based on the individual matrices, character images obtained from the individual glyphs included in the pieces of glyph information 700, 701, 702, . . . in the output image information 800.

In step S57, the output image 1100 is displayed in the display device 206 by the display control unit 415. At this time, the coordinates on the GUI screen 500 of the output image 1100 and rectangle information indicating the outline size of the output image 1100 are registered in the output image generating unit 417.

Thereafter, the output image 1100 displayed on the GUI screen 500 is modified in accordance with an input to the outline box input unit 416. A flow of modifying the output image 1100 is the same as that in the first embodiment, and thus the description thereof is omitted.

In the above-described embodiment, a description has been given about modification of the output image 1100 including a line, but the output image 1100 may include a plurality of lines. Also, a description has been given about character arrangement through modification on the right side of the output image 1100. However, the modification may be performed on the left side.

Furthermore, a description has been given about the case where transmission of character information from the client apparatus 102 to the server apparatus 101, generation of glyph information in the server apparatus 101, and transmission of the glyph information to the client apparatus 102 are repeated the number of times that is the same as the number of characters included in the text 610. However, in a case where overlapping pieces of character information 1800 exist in the client apparatus 102, transmission of the character information 1800 to the server apparatus 101 is performed only once. Also, once-generated glyph information may be cached in the server apparatus 101, and the cached glyph information may be taken out when an overlapping request is received.

Furthermore, a description has been given about the case of displaying text in horizontal writing in the client apparatus 102. However, the text may be displayed in vertical writing. In addition, a description has been given about the case where the server apparatus 101 generates image data to be printed. Alternatively, the client apparatus 102 may generate the image data.

As described above, according to the configuration of this embodiment, text included in the text information 600 is decomposed into characters, pieces of glyph information corresponding to the individual characters are generated, and an output image is generated by arranging the pieces of glyph information. Accordingly, a dynamic modification of an output image (character arrangement) can be performed only with the movement of the glyph 720 without communication with the server apparatus 101.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-260707 filed Oct. 7, 2008, which is hereby incorporated by reference herein in its entirety.

What is claimed is:

1. An image processing system including a server apparatus and a client apparatus connected to each other via a network,
the server apparatus comprising:
a storage unit configured to store pieces of rendering shape information of characters;
a receiving unit configured to receive text and pieces of font attribute information from the client apparatus; and
a first transmitting unit configured to transmit, to the client apparatus, pieces of rendering shape information corresponding to the received pieces of font attribute information among the pieces of rendering shape information of the characters stored in the storage unit,
the client apparatus comprising:
an input unit configured to input text and pieces of font attribute information;
a second transmitting unit configured to transmit, to the server apparatus, the text and the pieces of font attribute information that have been input;
a generating unit configured to generate an image corresponding to the text on the basis of pieces of rendering shape information received from the server apparatus; and
a display control unit configured to allow a display device to display the image generated by the generating unit,
wherein the first transmitting unit transmits, to the client apparatus, pieces of rendering shape information corresponding to individual characters included in the received text, and
wherein the generating unit generates images corresponding to the individual characters included in the text.

2. The image processing system according to claim 1,
wherein the second transmitting unit transmits, to the server apparatus, text and pieces of font attribute information corresponding to the text, and
wherein the first transmitting unit transmits, to the client apparatus, pieces of rendering shape information corresponding to the pieces of font attribute information while associating the pieces of rendering shape information with the individual characters included in the received text.

3. The image processing system according to claim 1,
wherein the second transmitting unit transmits, to the server apparatus, text and pieces of font attribute information corresponding to individual characters included in the text, and
wherein the first transmitting unit transmits, to the client apparatus, pieces of rendering shape information corresponding to the pieces of font attribute information.

4. The image processing system according to claim 1,
wherein each of the pieces of font attribute information includes a font family, and
wherein the first transmitting unit transmits pieces of rendering shape information corresponding to the font family.

5. The image processing system according to claim 1,
wherein the display control unit allows a plurality of images corresponding to individual characters generated by the generating unit to be displayed while arranging the images at intervals based on the pieces of rendering shape information corresponding to the individual characters.

6. The image processing system according to claim 1,
wherein each of the pieces of rendering shape information includes at least a glyph and metrics.

7. The image processing system according to claim 1,
wherein the client apparatus further comprises an editing unit configured to edit the image displayed by the display control unit on the basis of the pieces of rendering shape information received from the server apparatus.

8. The image processing system according to claim 7,
wherein the editing unit performs at least one of modification, scaling-up, scaling-down, and rotation of the image generated by the generating unit.

9. A server apparatus connected via a network to a client apparatus that inputs text and pieces of font attribute information and that generates images of characters on the basis of pieces of rendering shape information of the characters, the server apparatus comprising:
a storage unit configured to store pieces of rendering shape information of characters;
a receiving unit configured to receive text and pieces of font attribute information from the connected client apparatus; and
a transmitting unit configured to transmit, to the client apparatus, pieces of rendering shape information corresponding to the received pieces of font attribute information among the pieces of rendering shape information stored in the storage unit while associating the pieces of rendering shape information with individual characters in the received text.

10. A client apparatus connected via a network to a server apparatus that transmits pieces of rendering shape information corresponding to received pieces of font attribute information among pieces of rendering shape information of characters stored in accordance with the received pieces of font attribute information, the client apparatus comprising:
an input unit configured to input text and pieces of font attribute information;
a transmitting unit configured to transmit, to the server apparatus, the input text and the pieces of font attribute information corresponding to individual characters included in the text;
a generating unit configured to generate images of the characters included in the text on the basis of the pieces of rendering shape information of the individual characters received from the server apparatus; and
a display control unit configured to allow a display device to display the images generated by the generating unit.

11. A control method for a server apparatus connected via a network to a client apparatus that inputs text and pieces of font attribute information and that generates images of characters on the basis of pieces of rendering shape information of the characters, the server apparatus storing the pieces of rendering shape information of the characters, the control method comprising:
a receiving step of receiving text and pieces of font attribute information from the connected client apparatus; and
a transmitting step of transmitting, to the client apparatus, pieces of rendering shape information corresponding to the received pieces of font attribute information among the stored pieces of rendering shape information of the characters while associating the pieces of rendering shape information with individual characters in the received text.

12. A control method for a client apparatus connected via a network to a server apparatus that transmits pieces of rendering shape information corresponding to received pieces of font attribute information among pieces of rendering shape information of characters stored in accordance with the received pieces of font attribute information, the control method comprising:
an input step of inputting text and pieces of font attribute information;
a transmitting step of transmitting, to the server apparatus, the input text and the pieces of font attribute information corresponding to individual characters included in the text;
a generating step of generating images of the characters included in the text on the basis of the pieces of rendering shape information of the individual characters received from the server apparatus; and
a display control step of allowing a display device to display the generated images.

13. A computer-readable storage medium storing a computer-readable process, the computer-readable process causing a computer to execute the control method according to claim 12.
